(19) United States
(12) Patent Application Publication
(10) Pub. No.: US 2024/0310829 A1
(43) Pub. Date: Sep. 19, 2024

(54) DEVICE AND METHOD FOR DETERMINING INFORMATION FOR AT LEAST PARTIALLY IMPROVING OPERATION OF A SPINNING MILL

(71) Applicant: Maschinenfabrik Rieter AG, Winterthur (CH)

(72) Inventor: Nitin T. PATIL, Winterthur (CH)

(21) Appl. No.: 18/570,853

(22) PCT Filed: Jun. 21, 2022
(86) PCT No.: PCT/IB2022/055748

§ 371 Date: Dec. 15, 2023

(30) Foreign Application Priority Data
Jun. 24, 2021 (IN) 202141028390
Sep. 30, 2021 (EP) 21200079.8

(51) Int. Cl. G05B 23/02

(52) U.S. Cl. CPC G05B 23/0294; G05B 23/0272

(57) ABSTRACT

An electronic device and associated method of operation determine information for at least partially improving operation of a spinning mill. The electronic device is configured to: receive a plurality of event messages related to operation of the spinning mill from a computer network; from the plurality of event messages, determine recurring event messages and assign one or both of frequency information and time information to the recurring event messages; and based on one or both of the frequency and time information, process one or more of the recurring event messages to determine the information for at least partially improving operation of the spinning mill.

### FIELD OF INVENTION

This disclosure relates to a device and a method for determining information for at least partially improving operation of a spinning mill, the device and method configured to generate event messages related to operation of the spinning mill and to transmit the event messages via a computer network.

### DESCRIPTION OF RELATED ART

Spinning mills are designed for converting natural and man-made fibers and their blends into yarns of desired quantities and qualities. Spinning mills typically include large numbers of parts, namely large numbers of textile machines each possibly including a large number of subunits, as well as other components such as transport systems, power units, air conditioning systems, etc.

For monitoring operation of a spinning mill, various sensors are arranged at the parts of the spinning mill. The sensors are designed for detecting events related to operation of the spinning mill, such as sensors for detecting a sliver break, sensors for detecting a sliver jam, sensors for detecting a missing pressure in a drafting system, etc. Upon detection of an event, respective event messages are generated, for example by computerized devices connected with the sensors. The event messages are transmitted via a computer network for further processing. Event messages can have the form of text strings which identify the event, such as “a sliver break occurred at draw frame machine with label DF7”, “a sliver jam was detected at draw frame machine with label DF2”, “missing pressure at drafting system DS8”, etc. The event messages are transmitted via the computer network to further devices, such as to control devices, for further processing. For example, event messages can be transmitted to operator terminals for display on the operator terminals thereby informing operator persons about current events related to operation of the spinning mill. Depending on the event messages, operator persons may initiate respective actions, such as reinserting sliver, removing sliver congestion, checking pneumatic cylinders for pressure, etc. The event messages inform operator persons about a current state of the spinning mill, and actions related to the event messages may improve operation of the spinning mill, for example as regards performance, reliability, etc. of the spinning mill.

As a spinning mill typically includes large numbers of textile machines and large numbers of sensors, during operation of the spinning mill, a large number of different events may be detected. Accordingly, a large number of event messages may be generated and displayed on an operator terminal, for example. Each event may degrade operation of the spinning mill. Because of the large number of event messages which occur during operation of a spinning mill or which have been recorded until the end of a shift operation, it is difficult to determine from the event messages information for improving operation of the spinning mill.

CN109844193A, and counterpart EP3516099A1, disclose a system for predictive maintenance of a textile machine, which comprises a number of sensors. A reference value for each sensor is stored in a data base. During operation, each sensor of the textile machine is read. The signal of each sensor is correlated with the stored reference value. An alert or warning is given, if a single sensor data and a correlated sensor data show irregularities.

U.S. Pat. No. 3,789,595A discloses a spinning frame having a plurality of spindles with bobbins thereon being wound simultaneously with yarn. A travelling service tender monitors each spindle work station over a trip through all spindle positions to determine and correct malfunctions performed by an automatic service cycle performed at each spindle location work station requiring attention. Thus, full bobbins are detected and doffed, roll wraps are detected and stations disabled, flag down spindles are bypassed, and improper yarn feed is sensed and corrected by the service tender for each station encountered on a trip requiring such service.

### BRIEF SUMMARY OF THE INVENTION

There is a need for a device and a method for determining information for at least partially improving operation of a spinning mill which is configured to generate event messages related to operation of the spinning mill and to transmit the event messages via a computer network. Additional objects and advantages of the invention will be set forth in part in the following description, or may be obvious from the description, or may be learned through practice of the invention.

Such a need may be met by the subject-matter of the invention disclosed herein.

An aspect of the invention relates to an electronic device for at least partially improving operation of a spinning mill which is configured to generate event messages related to operation of the spinning mill and to transmit the event messages via a computer network. The electronic device is configured to receive from the computer network a plurality of event messages. The electronic device is configured to determine from the plurality of event messages recurring event messages and assign frequency information and/or time information to the recurring event messages. The electronic device is configured to process on the basis of the frequency information and/or the time information one or more recurring event messages for determining information for at least partially improving operation of the spinning mill.

The electronic device is also adapted for at least partially improving operation of a subset of a spinning mill, such as a single textile machine, an arrangement of textile machines, an arrangement of textile machines and auxiliary systems such as transport systems, etc.

The spinning mill includes sensors, devices, etc. for generating event messages in accordance to events occurring during operation of the spinning mill, such as a sliver break, sliver jam, etc. The event messages can be generated by respective computerized devices of the spinning mill which are connected with the sensors. The event messages can have the form of text strings. The event messages can have the form of text strings which identify and/or describe the event. The event messages can have the form of text strings which can be understood by a human. The spinning mill includes transmitters, encoders, network interfaces, etc. for transmitting event messages via a computer network. The electronic device includes receivers, decoders, network interfaces, etc. for receiving a plurality of event messages from the computer network. The electronic device includes logic functions for determining from the plurality of event messages recurring event messages, and for assigning frequency information and/or time information to the recurring event messages. The electronic device includes logic functions for processing the frequency information and/or time information, and for determining information for at least partially improve operation of the spinning mill. Information for at least partially improve operation of the spinning mill may relate to reasons, actions, etc. to remedy a degradation of the operation of the spinning mill caused by events which frequently occur, and/or to events which require time consuming maintenance.

In some embodiments, the electronic device is further configured to essentially continuously process one or more recurring event messages for determining information for at least partially improving operation of the spinning mill. Real-time information for improving operation of the spinning mill is enabled. Determining information for improving operation of the running spinning mill is enabled.

In some embodiments, the electronic device is configured to process one or more recurring event messages after lapse of a predefined timespan for determining information for at least partially improving operation of the spinning mill. The predefined timespan may relate to a work shift, to a current day, to a week, a month, customized, etc. Determining long-term information for improving operation of the spinning mill is enabled, for example long-term information for improving operation of the spinning mill during maintenance.

In some embodiments, the electronic device is further configured to assign frequency information in the form of a count of a respective recurring event message. The count enables simple processing for determining information for improving operation of the spinning mill.

In some embodiments, the electronic device is further configured to assign time information in the form of a duration of a respective recurring event message. The duration may relate to the duration of the event and/or to the duration to remedy the cause of the event. For example, in case of an event of short duration, information for improving operation of the spinning mill may be suppressed. For example, in case of a long duration to remedy the cause of the event, information for improving operation of the spinning mill may include warnings.

In some embodiment, the electronic device is further configured to include severity information of one or more recurring event messages for determining information for at least partially improving operation of the spinning mill. Information for improving operation of the spinning mill can be adapted to a severity of an event.

In some embodiments, the electronic device is further configured to include status information of the spinning mill for determining information for at least partially improving operation of the spinning mill, the status information relating in particular to one or more of performance information, quantity information, quality information, load information. Information for improving operation of the spinning mill can be adapted to the status of the spinning mill.

In some embodiments, the electronic device is further configured to include confirmation information originating from a user interface operable by an operator person and related to one or more recurring event messages for determining information for at least partially improving operation of the spinning mill. Information for improving operation of the spinning mill can be adapted to actions operator persons have performed and recorded via a user interface for handling of previous events.

In some embodiments, the electronic device is further configured to transmit information for at least partially improving operation of the spinning mill to an operator device for manually improving operation of the spinning mill.

In some embodiments, the electronic device is further configured to transmit information for at least partially improving operation of the spinning mill to a part of the spinning mill for automatically improving operation of the spinning mill.

In some embodiments, determining information for at least partially improving operation of the spinning mill includes comparing with a threshold value frequency information and/or time information of recurring event messages. Information for improving operation of the spinning mill may indicate that no action is required in case of events having a frequency and/or a duration below the threshold.

In some embodiments, determining information for at least partially improving operation of the spinning mill includes sorting recurring event messages according to frequency information and/or according to time information.

In some embodiments, determining information for at least partially improving operation of the spinning mill depends on comparing an effective productivity of the spinning mill with an expected productivity of the spinning mill.

The invention further relates to a method for determining information for at least partially improving operation of a spinning mill which is configured to generate event messages related to operation of the spinning mill and to transmit the event messages via a computer network. The method includes the steps executed by an electronic device of: receiving from the computer network a plurality of event messages; determining from the plurality of event messages recurring event messages and assigning frequency information and/or time information to the recurring event messages; processing on the basis of the frequency information and/or the time information one or more recurring event messages for determining information for at least partially improving operation of the spinning mill.

In some embodiments, the method further includes the step of essentially continuously processing one or more recurring event messages for determining information for at least partially improving operation of the spinning mill.

In some embodiments, the method further includes the step of processing one or more recurring event messages after lapse of a predefined timespan for determining information for at least partially improving operation of the spinning mill.

### BRIEF DESCRIPTION OF DRAWINGS

The invention will be better understood with the aid of the description of an embodiment given by way of example an illustrated by the figures, in which:

FIG. 1 illustrates schematically a spinning mill according to the prior art;

FIG. 2 illustrates schematically an electronic device according to the present invention:

FIG. 3 illustrates schematically a collection of recurring event messages, each having assigned frequency information and time information;

FIG. 4a, 4b illustrate schematically an alternative collection of recurring event messages, each having assigned frequency information and time information; and

FIG. 5 illustrates schematically possible method steps of a method for determining information for at least partially improving operation of a spinning mill which is configured to generate event messages related to operation of the spinning mill and to transmit the event messages via a computer network.

### DETAILED DESCRIPTION OF THE INVENTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

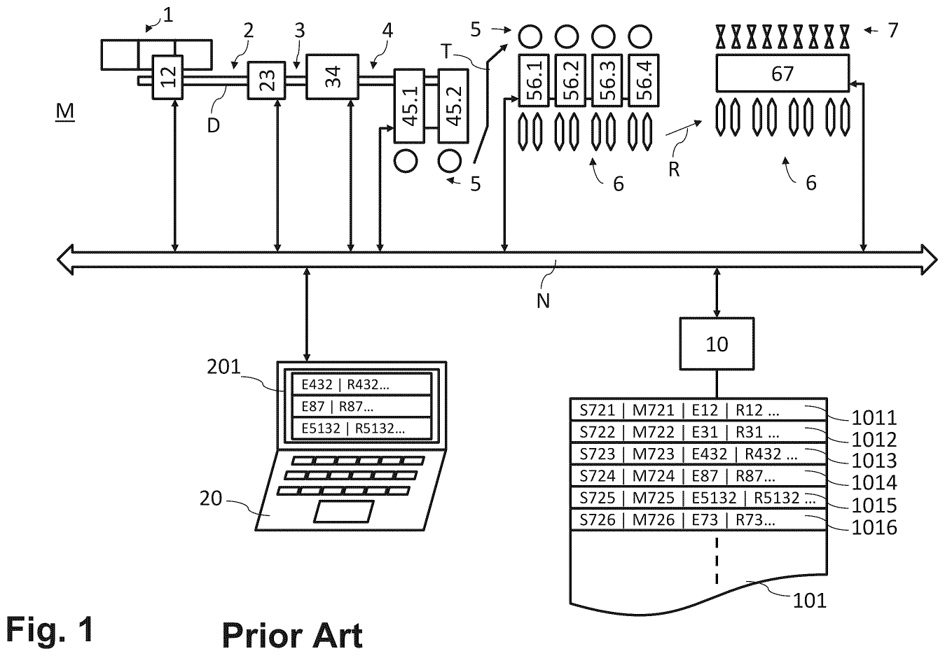

FIG. 1 illustrates schematically a spinning mill M according to the prior art. The spinning mill M includes several parts, namely machinery such as textile machines, systems such as computer systems and computer networks, components such as transport systems, etc., which are designed for building up the spinning mill M, and which are in particular designed for converting natural and man-made fibers and their blends into desired yarns.

The spinning mill M comprises exemplary textile machines 12, 23, 34, 45, 56, 67 for processing input textile materials 1, 2, 3, 4, 5, 6 into output textile materials 2, 3, 4, 5, 6, 7. In particular, the spinning mill M is configured for processing an input textile material 1, such as raw cotton, via intermediate textile materials 2, 3, 4, 5, 6 into a desired output textile material 7, such as yarn arranged on cones. Depending on the spinning mill M, the input textile material 1 and/or the desired output textile material 7, different types of textile machines 12, 23, 34, 45, 56, 67 and/or different sequences of textile machines 12, 23, 34, 45, 56, 67 may be involved for processing the input textile material 1 into the desired output textile material 7.

In typical spinning mills, one or more blow room textile machines may be arranged for processing raw cotton into chute matt. One or more carding textile machines may be arranged for processing chute matt into carded sliver. One or more breaker draw frame textile machines may arranged for processing carded sliver into break drawn sliver. One or more finisher draw frame textile machines may be arranged for processing break drawn sliver into finisher draw sliver. One or more speed frame textile machines may be arranged for processing finisher draw sliver into roving. One or more ring frame textile machines may be arranged for processing roving into ring cops. One or more winding textile machines may be arranged for processing ring cops into yarn cones.

At certain stages of the spinning mill M, a plurality of textile machines may be arranged, for example for providing enough capacity, for providing replacement textile machines in case of a failure of a running textile machine, etc. FIG. 1 illustrates schematically two textile machines 45.1, 45.2 for processing input textile material 4 into output textile material 5, and four textile machines 56.1, 56.2, 56.3, 56.4 for processing input textile material 5 into output textile material 6. Furthermore, textile machines may include subunits of identical or similar design, such as essentially identically designed spinning units, winding units, etc.

The spinning mill M may include duct system(s) D, trolley system(s) T, rail system(s) R, etc. for transporting textile material from one textile machine to another textile machine. The spinning mill M may include power stations, air conditioning systems, etc.

Thus, the spinning mill M includes a plurality of parts for processing the input textile material 1 into the desired output textile material 7.

As illustrated in FIG. 1, the parts of the spinning mill M, such as the textile machines 12, 23, 34, 45, 56, 67, etc., are connected to a computer network N. Furthermore, a control device 10 and an operator device 20 are connected to the computer network N. For connection with the computer network N, the textile machines 12, 23, 34, 45, 56, 67, etc., the control device 10, the operator device 20, etc. include respective network interfaces. The control device 10 and/or the operator device 20 are configured for monitoring and/or controlling via the computer network N operation of the spinning mill M, such as operation of the textile machines 12, 23, 34, 45, 56, 67, their subunits, if applicable, etc. The computer network N may conform to an IEEE 802 standard and may include wired and/or wireless networks. In some embodiments, analog and/or digital signal transmission devices (electrical, optical, etc.) may be arranged for providing connections between the parts of the spinning mill M, such as the textile machines 12, 23, 34, 45, 56, 67, etc., and the control device 10 and/or the operator device 20.

Furthermore, other parts of the spinning mill M, such as duct system(s) D, trolley system(s) T, rail system(s) R, power stations, air conditioning systems, etc. may also be connected with the computer network N, thereby being accessible by the control device 10 and/or the operator device 20.

Thus, parts and operation of the spinning mill M may be monitored and controlled by the control device 10 and/or the operator device 20.

The control device 10 and the operator device 20 may have the form of a single device.

A plurality of control devices and/or operator devices may be arranged for monitoring and/or controlling operation of the spinning mill M.

The control device 10 may be configured to monitor and/or to control the spinning mill M automatically or semi-automatically, for example for executing a predefined production task for converting an input textile material 1 into a desired output textile material 7. The operator device 20 may be configured to enable an operator person to monitor and control operation of the spinning mill M, for example for monitoring and/or controlling operating parameters of parts of the spinning mill M, such as of the textile machines 12, 23, 34, 45, 56, 67, etc. Operating parameters may relate to rotation speeds, throughput, etc.

The control device 10, the operator terminal 20 and an electronic device 30 as will be described below according to the present invention may take the form of a computer, for example a computer that is generally used in one place (such as a conventional desktop computer, workstation, server, etc.) or a computer that is generally portable (such as a laptop, notebook, tablet, handheld computer, etc.). Such a computer may include a machine-readable medium having stored thereon instructions which program one or more processors to perform some or all of the operations and functions described in this disclosure. A machine-readable medium may include any mechanism for storing or transmitting information in a form readable by a machine (e.g., a computer), such as Hard Disk drives (HD), Solid State Disk drives (SSD), Compact Disc Read-Only Memory (CD-ROMs), Read-Only Memory (ROMs), Random Access Memory (RAM), Erasable Programmable Read-Only Memory (EPROM), etc. In other embodiments, some or all of these operations and functions might be performed by specific hardware components that contain hardwired logic. Those operations and functions might alternatively be performed by any combination of programmable computer components and fixed hardware circuit components. In some embodiments, the machine-readable medium includes instructions stored thereon, which, when executed by one or more processors of a computer, cause the computer to perform the methods as described in this disclosure.

In a running spinning mill M, at one or more parts of the spinning mill M, such as at textile machines 12, 23, 34, 45, 56, 67, at subunits thereof, etc., events related to operation of the spinning mill M may be detected, for example on the basis of sensors arranged at respective locations. According to events related to operation of the spinning mill M, respective event messages 1011, 1012, 1013, 1014, 105, 1016 may be generated by respective devices attached to the spinning mill M, such as computerized devices attached to the textile machines 12, 23, 34, 45, 56, 67, etc., and transmitted via the computer network N to the control device 10 and/or the operator device 20. Textile machines 12, 23, 34, 45, 56, 67, duct system(s) D, trolley system(s) T, rail system(s) R, power stations, air conditioning systems, etc. may be configured to generate and transmit, upon detection of an event, respective event messages 1011, 1012, 1013, 1014, 1015, 1016 via the computer network N.

Event messages 1011, 1012, 1013, 1014, 1015, 1016 may have the form of text strings. Event messages 1011, 1012, 1013, 1014, 1015, 1016 may conform with a markup language such as XML (extended Markup Language), HTML (HyperText Markup Language), etc.

Event messages 1011, 1012, 1013, 1014, 1015, 1016 may include status information, error information, location information, time information, etc. related to operation of the spinning mill M. Event messages 1011, 1012, 1013, 1014, 1015, 1016 may relate to the engagement of an emergency stop, a sliver break, a missing infeed sliver, a sliver jam, a pressure failure at a drafting system, a lap-up at a drafting system, etc. Event messages 1011, 1012, 1013, 1014, 1015, 1016 may include reason information, which may further include action information. Reason resp. action information may include instructions for handling an event, for example to disengage an emergency stop, to check a sliver path, to reinsert sliver, to check adjustments of contact on rollers, to remove a sliver congestion, to remove excess material, to check pneumatic cylinders, to remove a lap in a drafting system, etc. Reason resp. action information may relate to remedy instructions to remedy deficiencies caused by the event. Reason resp. action information may relate to suggestions for improving operation of a part, to suggestions for preventive maintenance, etc. Reason resp. action information may relate to instructions for handling an event automatically, semi-automatically or manually. Event messages 1011, 1012, 1013, 1014, 1015, 1016 may include unique identifiers enabling lookup of further information related to events in a database.

As illustrated in FIG. 1, the control device 10 and/or the operator terminal 20 may be configured for receiving event messages 1011, 1012, 1013, 1014, 1015, 1016. For example, the control device 10 may be configured for storing event messages 1011, 1012, 1013, 1014, 1015, 1016 in an event database 101. Event messages 1011, 1012, 1013, 1014, 1015, 1016 may include serial numbers S . . . , time information M . . . indicating the time of occurrence of the event, event descriptions E . . . , reason resp. action information R . . . for handling the event, etc. Event messages 1011, 1012, 1003, 1014, 1015, 1016 stored in the database 101 may include further event-related information, for example location information, severity information, etc.

Databases as described in the present disclosure may relate to databases stored in a memory of a device, stored on a database server, stored in a cloud, etc.

As illustrated in FIG. 1, the operator device 20 may be configured for displaying information 201 related to the event messages 1011, 1012, 1013, 1014, 1015, 1016 on a display 201 of the operator device 20, thereby informing operator persons about events at parts of the spinning mill M resp. thereby enabling operator persons to take action for handling events at parts of the spinning mill M. Information 201 related to the event messages 1011, 1012, 1013, 1014, 1015, 1016 may include event descriptions E . . . and reason resp. action information R . . . for handling the event. Further event-related information may be displayed, for example location information, severity information, etc.

A typical spinning mill M includes large numbers of parts, such as large numbers of textile machines 12, 23, 34, 45, 56, 67, each possibly including large numbers of subunits, etc. Accordingly, the spinning mill M includes large numbers of sensors for sensing various events related to the parts of the spinning mill M. Therefore, during operation of the spinning mill M, or at the end of a shift operation of the spinning mill M, large numbers of event messages 1011, 1012, 1013, 1014, 1015, 1016 are, or were, generated.

Each event may degrade operation of the spinning mill M. Except of sequentially handling event messages 1011, 1012, 1013, 1014, 1015, 1016, it is difficult to determine from the event messages 1011, 1012, 1013, 1014, 1015, 1016 information for improving operation of the spinning mill M.

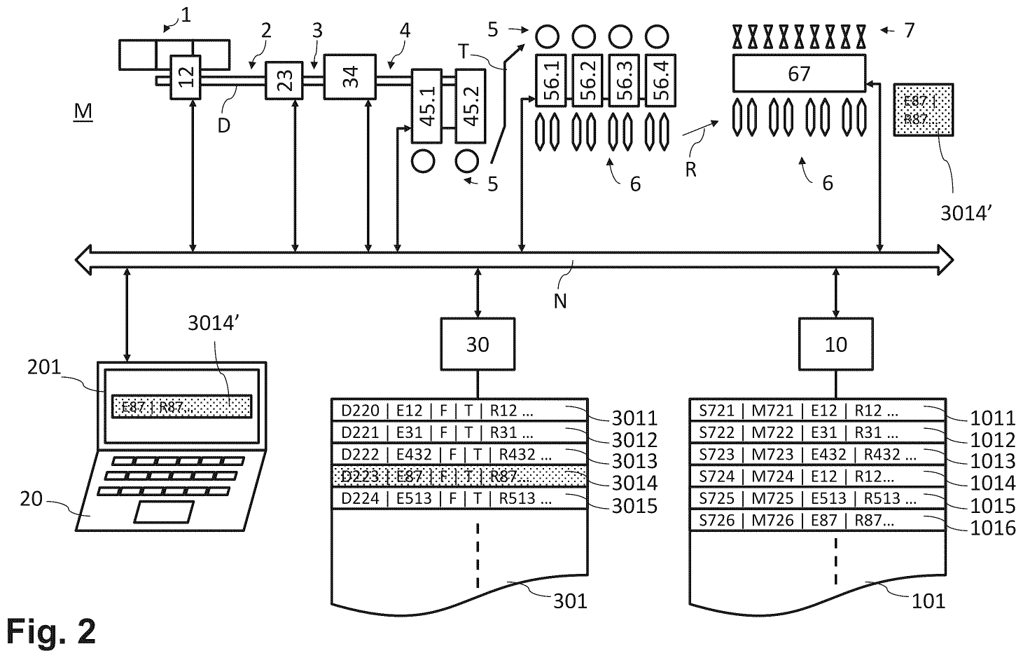

FIG. 2 illustrates schematically an electronic device 30 according to the present invention. As illustrated in FIG. 2, the electronic device 30 is arranged in the spinning mill M according to the prior art as illustrated in FIG. 1, for example. As will be described further below, the electronic device 30 is configured for determining information for at least partially improving operation of the spinning on the basis of event messages 1011, 1012, 1013, 1014, 1015, 1016 related to operation of the spinning mill M.

The electronic device 30 may have the form of a computer and/or may have the form of a hardwired logic circuit, as described above. The electronic device 30 may be arranged in the form of a subunit of the control device 10 (not illustrated), for example in the form of respective program instructions stored in a memory of the control device 10, wherein the program instructions enable a processor of the control device 10 to provide operations and functions of the electronic device 30 as described in the present disclosure. Alternatively (not illustrated), the electronic device 30 may be arranged in a similar manner as a subunit of the operator device 20. Alternatively (not illustrated), the control device 10, the operator device 20 and the electronic device 30 form a single device.

The electronic device 30 is configured to receive via the computer network N event messages 1011, 1012, 1013, 1014, 1015, 1016 related to operation of the spinning mill M. Event messages 1011, 1012, 1013, 1014, 1015, 1016 relate to events at parts of the spinning mill M, such as events at the textile machines 12, 23, 34, 45, 56, 67, from subunits thereof, etc. The electronic device 30 may be configured to receive event messages 1011, 1012, 1013, 1014, 1015, 1016 from the event database 101 of the control device 10.

The electronic device 30 is configured to determine recurring event messages 3011, 3012, 3013, 3014, 3015 and to assign frequency information F and/or time information T to the recurring event messages 3011, 3012, 3013, 3014, 3015.

Recurring event messages 3011, 3012, 3013, 3014, 3015 may be determined by comparison of event descriptions E . . . , unique identifiers, etc. of the event messages 1011, 1012, 1013, 1014, 1015, 1016.

Recurring event messages 3011, 3012, 3013, 3014, 3015 may be determined on the basis of the same or similar event descriptions E . . . , unique identifiers, etc. of the event messages 1011, 1012, 1013, 1014, 1015, 1016.

Recurring event messages 3011, 3012, 3013, 3014, 3015 may include the same or similar reason reps. action information R . . . for handling the event as the reason resp. action information R . . . of the event messages 1011, 1012, 1013, 1014, 1015, 1016.

Recurring event messages 3011, 3012, 3013, 3014, 3015 may include database identifiers D . . . , for example for the purpose of storing the recurring event messages 3011, 3012, 3013, 3014, 3015 in a database 301.

Assigning frequency information F and/or time information T to the recurring event messages 3011, 3012, 3013, 3014, 3015 may be based on time information M . . . of the event messages 1011, 1012, 1013, 1014, 1015, 1016.

Frequency information F may relate to a number of events which occurred in a certain time period, such as the number of events which occurred in one hour, during a shift operation, etc.

Time information T may relate to a time period between the occurrence of the event and the handling of the event, which may be detected based on a respective event message generated at a respective part of the spinning mill M after handling of the event. According to one variant, at least one event message can be triggered manually by a person. For example, the confirmation of the successful solution of a problem by acknowledgement at a control terminal is possible. Alternatively, or in addition, the handling of an event can also be determined automatically, for example by a control system based on control values or measured sensor data, and a corresponding time can be determined. The time of the start of the handling and/or the time of the completion of the actions that have become necessary due to the event may be applied. Thus, in one variant, time information T can be, for example, the duration between the notification of a detected error until the beginning of the handling of the error and/or until the successful remedying of the error.

As illustrated in FIG. 2, the electronic device 30 may be configured to store recurring event messages 3011, 3012, 3013, 3014, 3015 in a database 301, together with respective frequency information F and/or time information T.

The electronic device 30 is configured to process on the basis of the frequency information F and/or the time information T one or more recurring event messages 3011, 3012, 3013, 3014, 3015 for determining information for at least partially improving operation of the spinning mill M.

For example, determining information for at least partially improving operation of the spinning mill M may include selecting from the recurring event messages 3011, 3012, 3013, 3014, 3015 the recurring event message with a frequency information F indicating an event frequency which is particularly high with respect to frequency information F of other recurring event messages. Alternatively, or in addition, an event frequency can be indicated that has changed over a certain period of time. For example, if an event occurs more frequently in a certain current period than in a previous period.

For example, determining information for at least partially improving operation of the spinning mill M may include selecting from the recurring event messages 3011, 3012, 3013, 3014, 3015 the recurring event message with a time information T indicating a time for handling the event which is particularly long with respect to time information of other recurring event messages. Alternatively, or in addition, a time for handling the event can be indicated that has changed over a certain period of time. For example, if a time for handling (e.g. average time for handling the event) for a certain event is longer in a certain current period than in a previous period.

The electronic device 30 may be further configured to determine severity information of one or more recurring event messages 3011, 3012, 3013, 3014, 3015 for determining information for at least partially improving operation of the spinning mill M. Severity information may relate to a severity level. For example, severity of sliver breaks at an upstream textile machine may be higher than severity of sliver breaks at a downstream textile machine having the same frequency, and information for at least partially improving operation of the spinning mill may include reason resp. action information for handling events at the upstream textile machine sooner than events of the downstream textile machine.

The electronic device 30 may be further configured to include status information of the spinning M for determining information for at least partially improving operation of the spinning mill M. Status information may include performance information, quantity information, quality information, etc. of the textile materials, and/or power consumption, load information, etc. of the spinning mill M and/or of parts of the spinning mill M. For example, in case quality of the textile material produced by a textile machine falls below a threshold and frequency of events at that textile machine is above a threshold, information for at least partially improving operation of the spinning mill M may include reason resp. action information for handling events of that textile machine sooner than events of other parts of the spinning mill.

The electronic device 30 may be further configured to include confirmation information originating from a user interface operable by an operator person and related to one or more recurring event messages 3011, 3012, 3013, 3014, 3015 for determining information for at least partially improving operation of the spinning mill M. For example, confirmation information may relate to a count or to a ratio of confirmations of operator persons indicating that respective event messages 1011, 1012, 1013, 1014, 1015, 1016 and/or respective recurring event messages 3011, 3012, 3013, 3014, 3015 were handled, or were classified as unimportant and therefore were not handled. Often operator persons may assume that event messages 1011, 1012, 1013, 1014, 1015, 1016 and/or respective recurring event messages 3011, 3012, 3013, 3014, 3015 are unimportant, and therefore do not take any action. Based on confirmation information, the electronic device 30 may be configured to adapt information for at least partially improving operation of the spinning mill accordingly.

As illustrated in FIG. 2, on the basis of frequency information F and/or time information T, one of the recurring events 3011, 3012, 3013, 3014, 3015, in the example of FIG. 2 the recurring event 3014, may be determined as information for at least partially improving operation of the spinning mill M, which information may in particular include reason resp. action information, in the example of FIG. 2 reason resp. action information R87, for handling the event. The electronic device 30 may be configured to transmit respective information 3014′, which may include the event E87 and the reason resp. action for handling the event R87 to the operator device 20 for display on the display 201 of the operator device. Alternatively, or additionally, respective information 3014″ may be transmitted to the controller 10 and/or a respective part of the spinning mill M, for example to textile machine 67, in particular for initiating an automatic handling of the event for improving operation of the spinning mill M.

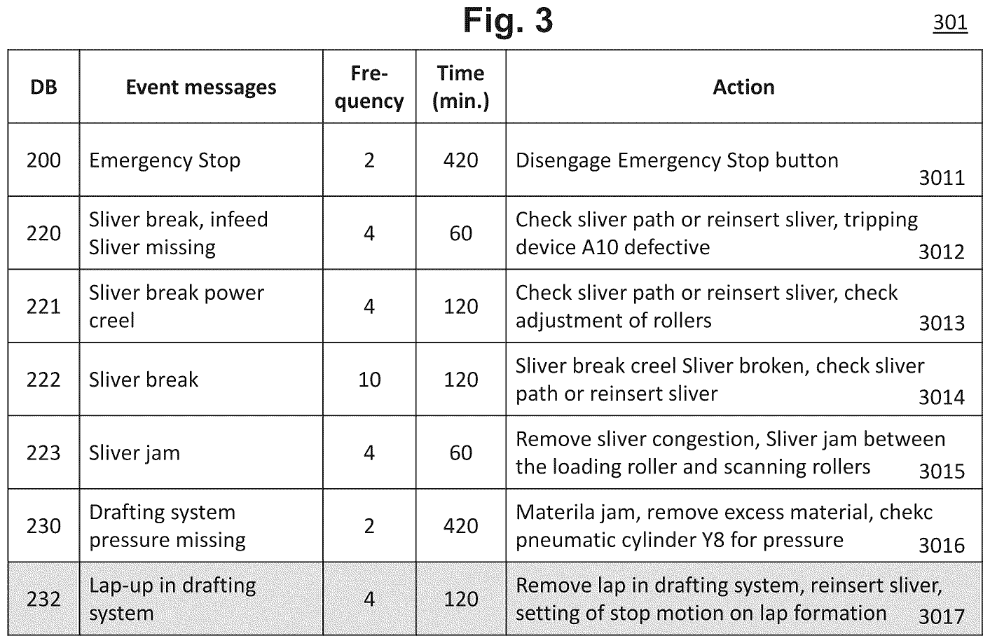

FIG. 3 illustrates an exemplary database 301 having stored recurring event messages 3011, 3012, 3013, 3014, 3015, 3016, 3017 determined by the electronic device 30. The recurring event messages 3011, 3012, 3013, 3014, 3015, 3016, 3017 may relate to event messages 1011, 1012, 1013, 1014, 1015, 1016 which were received in the electronic device 30 during a predefined time period, such as during the last 10 minutes, during the last 30 minutes, during the last 2 hours, etc.

The recurring event messages 3011, 3012, 3013, 3014, 3015, 3016, 3017 stored in the database 301 include an identifier DB, an event message, frequency information F, time information T, and reason resp. action information.

For determining information for at least partially improve operation of the spinning mill M, frequency information F are processed, as well as severity information of the event messages, for example. In the example illustrated in FIG. 3, the recurring event message 3014 indicates the highest frequency of 10, while the recurring event messages 3012, 3013, 3015, 3017 indicate a frequency of 4, and the recurring event messages 3011, 3016 indicate a frequency of 2. The electronic device 30 is configured to include severity information (not illustrated) related to the recurring event messages 3011, 3012, 3013, 3014, 3015, 3016, 3017 for determining information for at least partially improving operation of the spinning mill M, with the result in the particular example of FIG. 3 that recurring event message 3017 provides the information for improving the operation of the spinning mill M, in particular the reason resp. action of the recurring event message 3017 indicating “remove lap in drafting system, reinsert sliver, setting of stop motion on lap formation”, which information may be displayed on the operator device 20, for example, or which information may be further processed in the control device 10 for automatic handling, if applicable.

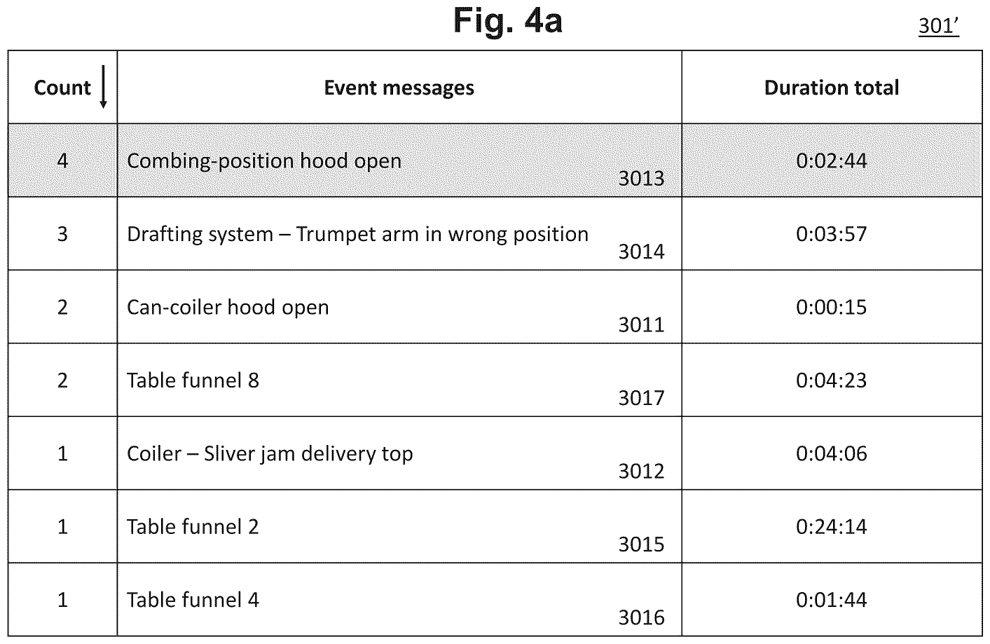

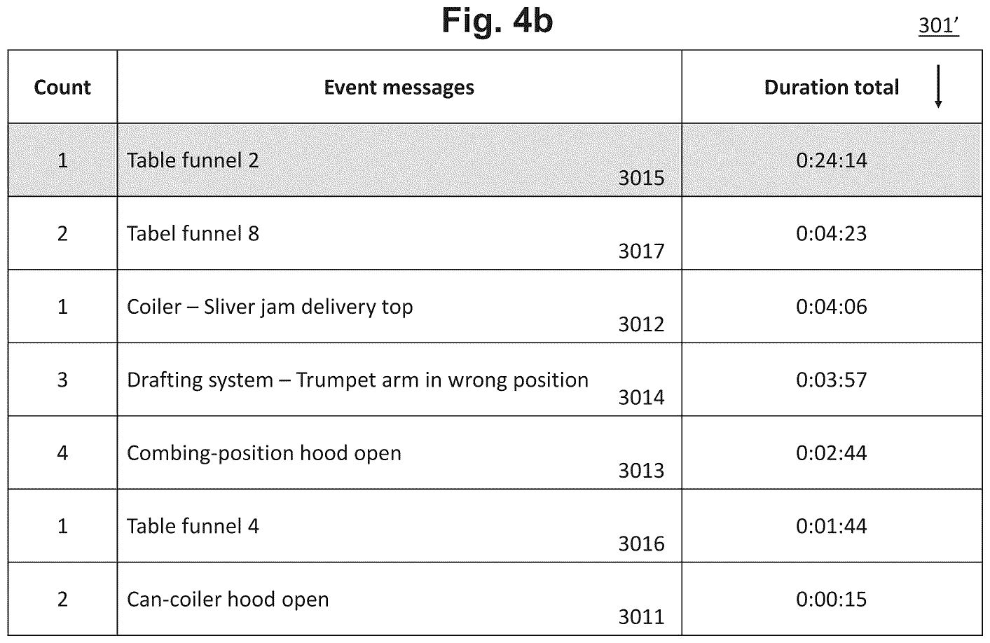

FIG. 4a, 4b illustrate schematically an exemplary alternative database 301′ having stored recurring event messages 3011, 3012, 3013, 3014, 3015, 3016, 3017 determined by the electronic device 30. The recurring event messages 3011, 3012, 3013, 3014, 3015, 3016, 3017 may relate to event messages 1011, 1012, 1013, 1014, 1015, 1016 which were received in the electronic device 30 during a work shift, such as during a work shift of 8 hours for processing input textile material 1 into output textile material 7.

The recurring event messages 3011, 3012, 3013, 3014, 3015, 3016, 3017 stored in the database 301′ include a count, an event message, and a total duration. The count may relate to the number of event messages 1011, 1012, 1013, 1014, 1015, 106 related to the respective recurring event message. The total duration may relate to the required time for handling the event related to the respective recurring event message.

As illustrated in FIG. 4a, the recurring event messages 3011, 3012, 3014, 3015, 3016, 3017 may be sorted according to their count. As illustrated in the example of FIG. 4a, the recurring event message 3013 “combining-position hood open” indicates a count of 4, the recurring event message 3014 “drafting system—trumpet arm in wrong position” indicates a count of 3, etc. The electronic device 30 may be configured to determine information for improving operation of the spinning mill depending on the highest count and may include reason resp. action information for display on an operator device 20, and/or for automatic processing in the control device 10. In this example, the information for improving operation of the spinning mill M may include reason resp. action information related to the event “combining-position hood open”.

As illustrated in FIG. 4b, the recurring event messages 3011, 3012, 3014, 3015, 3016, 3017 may be sorted according to their total duration. As illustrated in the example of FIG. 4a, the recurring event message 3015 “table funnel 2” indicates a total duration of 0:24:14, the recurring event message 3014 “table funnel 8” indicates a total duration of 0:04:23, etc. The electronic device 30 may be configured to determine information for improving operation of the spinning mill depending on the longest duration and may include reason resp. action information for display on an operator device 20, and/or for automatic processing in the control device 10. In this example, the information for improving operation of the spinning mill M may include reason resp. action information related to the event “table funnel 2”.

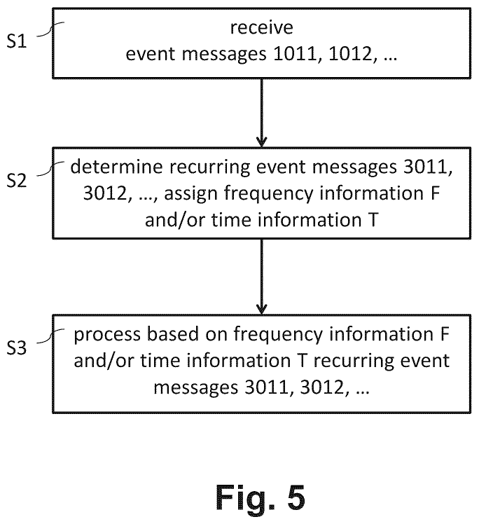

FIG. 5 illustrates schematically possible method steps of a method for determining information for at least partially improving operation of a spinning mill which is configured to generate event messages related to operation of the spinning mill and to transmit the event messages via a computer network N, the method being executed by an electronic device 30. In step S1, a plurality of event messages 1011, 1012, 1013, 1014, 1015, 1016 related to operation of the spinning mill M is received via computer network N. In step S2, recurring event messages 3011, 3012, 3014, 3014, 3015 related to the one or parts of the spinning mill M are determined from the plurality of event messages 1011, 1012, 1013, 1014, 1015, 1016 and frequency information F and/or time information T is assigned to the recurring event messages 3011, 3012, 3013, 3014, 3015. In step S3, on the basis of the frequency information F and/or the time information T, one or more recurring event message 3011, 3012, 3013, 3014, 3015 is processed for determining information for at least partially improving operation of the spinning mill M.

### REFERENCE NUMERALS/SIGNS

M spinning mill
1, 2, 3, 4, 5, 6, 7 textile materials
12, 23, 34, 45, 56, 67 textile machines
N computer network
D duct system
T trolley system
R rail system
10 control device
20 operator device
30 electronic device
1011, 1012, 1013, 1014, 1015, 1016 event messages
3011, 3012, 3013, 3014, 3015, 3016 recurring event messages
F frequency information
T time information
E . . . event
R . . . reason resp. action information

1-16. (canceled)

17. An electronic device that determines information for at least partially improving operation of a spinning mill, the electronic device configured to:
receive a plurality of event messages related to operation of the spinning mill from a computer network;
from the plurality of event messages, determine recurring event messages and assign one or both of frequency information and time information to the recurring event messages;
based on one or both of the frequency and time information, process one or more of the recurring event messages to determine the information for at least partially improving operation of the spinning mill.

18. The electronic device according to claim 17, further configured to continuously process the one or more recurring event messages to determine the information for at least partially improving operation of the spinning mill.

19. The electronic device according to claim 17, further configured to process the one or more recurring event messages after lapse of a predefined timespan to determine the information for at least partially improving operation of the spinning mill.

20. The electronic device according to claim 17, further configured to assign the frequency information in a form of a count of the one or more recurring event messages to determine the information for at least partially improving operation of the spinning mill.

21. The electronic device according to claim 17, further configured to assign the time information in a form of a duration of the one or more recurring event messages to determine the information for at least partially improving operation of the spinning mill.

22. The electronic device according to claim 17, further configured to determine severity information for the one or more recurring event messages to determine the information for at least partially improving operation of the spinning mill.

23. The electronic device according to claim 17, further configured to determine status information of the spinning mill to determine the information for at least partially improving operation of the spinning mill, the status information relating to one or more of performance information, quantity information, quality information, and load information.

24. The electronic device according to claim 17, further configured to include confirmation information originating from a user interface operable by an operator person and related to the one or more recurring event messages to determine the information for at least partially improving operation of the spinning mill.

25. The electronic device according to claim 17, further configured to transmit the information for at least partially improving operation of the spinning mill to an operator device to be used to manually improving operation of the spinning mill.

26. The electronic device according to claim 17, further configured to transmit the information for at least partially improving operation of the spinning mill to a part of the spinning mill to automatically reconfigure the spinning mill to improve operation of the spinning mill.

27. The electronic device according to claim 17, further configured to compare one or both of the frequency and time information of the recurring event messages to a threshold value to determine the information for at least partially improving operation of the spinning mill.

28. The electronic device according to claim 17, further configured to sort the recurring event messages according to one or both of the frequency and time information of the recurring event messages to determine the information for at least partially improving operation of the spinning mill.

29. The electronic device according to claim 17, further configured to compare an effective productivity of the spinning with an expected productivity to determine the information for at least partially improving operation of the spinning mill.

30. A method executed by an electronic device for determining information for at least partially improving operation of a spinning mill on the basis of event messages related to operation of the spinning mill that are transmitted via a computer network, the method comprising:
receiving a plurality of the event messages related to operation of the spinning mill from the computer network;
from the plurality of event messages, determining recurring event messages and assigning one or both of frequency information and time information to the recurring event messages;
based on one or both of the frequency and time information, processing one or more of the recurring event messages to determine the information for at least partially improving operation of the spinning mill.

31. The method according to claim 30, further comprising continuously processing the one or more recurring event messages to determine the information for at least partially improving operation of the spinning mill.

32. The method according to claim 30, further comprising processing the one or more recurring event messages after lapse of a predefined timespan to determine the information for at least partially improving operation of the spinning mill.
